(19) United States
(12) Patent Application Publication
(10) Pub. No.: US 2020/0055185 A1
(43) Pub. Date: Feb. 20, 2020

(54) ROBOT AND METHOD OF OPERATING THE SAME

(71) Applicant: KAWASAKI JUKOGYO KABUSHIKI KAISHA, Kobe-shi, Hyogo (JP)

(72) Inventors: Kazunori HIRATA, Yao-shi (JP); Masashi MISAWA, Kakogawa-shi (JP)

(73) Assignee: KAWASAKI JUKOGYO KABUSHIKI KAISHA, Kobe-shi, Hyogo (JP)

(21) Appl. No.: 16/500,512

(22) PCT Filed: Mar. 30, 2018
(86) PCT No.: PCT/JP2018/013573

§ 371 Date: Oct. 3, 2019

(30) Foreign Application Priority Data
Apr. 3, 2017 (JP) 2017-074060

(51) Int. Cl. B25J 9/16; B25J 9/04; B25J 11/00; B65G 59/06; B65G 59/10

(52) U.S. Cl. CPC B25J 9/1612; B25J 9/043; B65G 59/106; B25J 11/0045; B65G 59/061; B25J 9/044

(57) ABSTRACT

A robot is configured such that: a second hand of a second arm holds a container stack by gripping a top portion of a bottom container of the container stack; then, a first hand of a first arm holds the container stack by gripping a portion of the bottom container of the container stack, such that the portion gripped by the first hand is positioned lower than the portion gripped by the second hand; thereafter, the second hand of the second arm releases the top portion of the bottom container, and then holds the container stack by gripping the top portion of a second container from a bottom of the container stack; and subsequently, the first hand of the first arm moves the bottom container downward, and separates the bottom container from the container stack.

### TECHNICAL FIELD

The present invention relates to a robot and a method of operating the same.

### BACKGROUND ART

Conventionally, there are known automatic cup-feeding techniques. For example, there is a known technique in which a cup-separating cum is provided such that the cup-separating cum is engaged with a stack of cups, and as a result of the cup-separating cum rotating once, only the bottom one of the cups is separated from the stack, and falls off (see Patent Literature 1, for example).

There is another known technique in which a blade-shaped stopper is inserted between the lips of adjacent paper cups in a paper cup stack, and thereby paper cups are separated from the stack (see Patent Literature 2, for example).

There is yet another known technique in which a claw of an air cylinder is projected, and the top edge of a bottom one of paper cups is pushed down by the projected claw, thereby separating the bottom paper cup from the immediately above paper cup (see Patent Literature 3, for example).

### CITATION LIST

### Patent Literature

PTL 1: Japanese Laid-Open Patent Application Publication No. 2002-230639 (see, in particular, paragraph [0003] and FIG. 3)

PTL 2: Japanese Laid-Open Patent Application Publication No. H04-078109 (see, in particular, FIG. 1)

PTL 3: Japanese Utility Model Registration No. 3090574 (see, in particular, paragraph [0006] and FIG. 4)

### SUMMARY OF INVENTION

### Technical Problem

In recent years, in various fields, it has been proposed that a robot and a worker should work together in the same working space in cooperation with each other in order to improve productivity. However, in the above-described conventional techniques, no robot is used for automatic cup feeding. Here, cups are merely one example of containers, and it is preferable to be able to automatically feed the widest possible variety of containers.

The present invention has been made to solve the above-described problems, and an object of the present invention is to provide a robot capable of automatically feeding containers by using arms and a method of operating the robot.

### Solution to Problem

In order to solve the above-described problems, a robot according to one aspect of the present invention is a robot for sequentially separating containers from a container stack. Each of the containers has an open top portion, a closed bottom portion, and such a shape that each container gets gradually thinner from the top portion to the bottom portion. The container stack is a stack of the containers that are sequentially stacked such that every two containers adjacent to each other in an upward-downward direction in the stack are arranged in such a manner that an upper one of the two containers is inserted from its bottom portion into an internal space of a lower one of the two containers, such that the top portion of the upper container is exposed. The robot includes: a second arm including a second hand at a distal end thereof, the second hand being operable to grip each of the containers; a first arm including a first hand at a distal end thereof, the first hand being operable to grip each of the containers; and a controller configured to control operations of the first and second arms. The controller is configured to control the first and second arms such that: the second hand of the second arm holds the container stack by gripping the top portion of a bottom one of the containers of the container stack; then, the first hand of the first arm holds the container stack by gripping a portion of the bottom container of the container stack, such that the portion gripped by the first hand is positioned lower than the portion gripped by the second hand; thereafter, the second hand of the second arm releases the top portion of the bottom container, and then holds the container stack by gripping the top portion of a second container from a bottom of the container stack; and subsequently, the first hand of the first arm moves the bottom container downward, and separates the bottom container from the container stack.

According to the above configuration, the first and second arms hold the container stack by the second arm, then re-hold it by the first arm, and thereafter re-hold it by the second arm, sequentially. In a state where the second arm holds the container stack by gripping the top portion of the second container from the bottom of the container stack, the first arm moves the bottom container downward, thereby separating the bottom container from the container stack. In this manner, automatic feeding of each container can be performed by using the arms. In addition, since the feed speed of the containers depends on the operating speed of the arms, by increasing the operating speed of the arms, the feed speed of the containers (i.e., work efficiency) can be improved.

The controller may be configured to control the first and second arms such that: when the second hand of the second arm holds the container stack by gripping the top portion of the bottom container of the container stack, the second hand is positioned at a predetermined height position, and then, the second hand moves upward by a predetermined height before the second hand grips the top portion of the second container from the bottom of the container stack, and the second hand returns to the predetermined height position after the first hand of the first arm has moved the bottom container downward.

According to the above configuration, the operation by the second hand of the second arm to hold the container stack at the predetermined height position is the starting operation of the container separating operation, and the operation by the second hand to return to the predetermined height position after the first hand of the first arm has moved the bottom container downward is the ending operation of the container separating operation. This makes it possible to repeatedly perform the container separating operation.

Each of the first hand and the second hand may be configured to grip each of the containers by applying sandwiching force to the gripped container in a horizontal direction.

According to the above configuration, each of the containers of the container stack, in which the containers are sequentially stacked upward, can be properly gripped.

Each of the containers may be a cup.

According to the above configuration, in a state where the second arm holds the container stack by gripping the top portion of the second container from the bottom of the container stack, the first arm grips and moves the bottom container downward, thereby separating the bottom container from the container stack. Accordingly, even if the container stack is a cup stack in which adjacent cups are closely in contact with each other due to the elasticity of the cups, each of the cups can be properly separated from the cup stack.

A method of operating a robot according to another aspect of the present invention is a method of operating a robot for sequentially separating containers from a container stack. Each of the containers has an open top portion, a closed bottom portion, and such a shape that each container gets gradually thinner from the top portion to the bottom portion. The container stack is a stack of the containers that are sequentially stacked such that every two containers adjacent to each other in an upward-downward direction in the stack are arranged in such a manner that an upper one of the two containers is inserted from its bottom portion into an internal space of a lower one of the two containers, such that the top portion of the upper container is exposed. The robot includes: a second arm including a second hand at a distal end thereof, the second hand being operable to grip each of the containers; and a first arm including a first hand at a distal end thereof, the first hand being operable to grip each of the containers. The method includes: holding the container stack by gripping the top portion of a bottom one of the containers of the container stack by the second hand of the second arm; then, holding the container stack by gripping a portion of the bottom container of the container stack by the first hand of the first arm, such that the portion gripped by the first hand is positioned lower than the portion gripped by the second hand; thereafter, releasing the top portion of the bottom container by the second hand of the second arm; then, holding the container stack by gripping the top portion of a second container from a bottom of the container stack by the second hand of the second arm; and subsequently, moving the bottom container downward and separating the bottom container from the container stack by the first hand of the first arm.

According to the above configuration, the first and second arms hold the container stack by the second arm, then re-hold it by the first arm, and thereafter re-hold it by the second arm, sequentially. In a state where the second arm holds the container stack by gripping the top portion of the second container from the bottom of the container stack, the first arm moves the bottom container downward, thereby separating the bottom container from the container stack. In this manner, automatic feeding of each container can be performed by using the arms. In addition, since the feed speed of the containers depends on the operating speed of the arms, by increasing the operating speed of the arms, the feed speed of the containers (i.e., work efficiency) can be improved.

### Advantageous Effects of Invention

The present invention has an advantage of being able to provide a robot capable of automatically feeding containers by using arms and a method of operating the robot.

### BRIEF DESCRIPTION OF DRAWINGS

FIG. 1 is a front view showing the configuration of a robot according to an embodiment of the present invention.

FIG. 2 is a perspective view showing the configurations of hands of the dual-arm robot of FIG. 1, the perspective view illustrating an application example (usage example) of the dual-arm robot.

FIG. 3 is a functional block diagram showing the configuration of a control system of the dual-arm robot of FIG. 1.

FIG. 4 is a flowchart showing operations of the dual-arm robot of FIG. 1.

FIG. 5A is a perspective view showing an operation of the dual-arm robot of FIG. 1.

FIG. 5B is a perspective view showing an operation of the dual-arm robot of FIG. 1.

FIG. 5C is a perspective view showing an operation of the dual-arm robot of FIG. 1.

FIG. 5D is a perspective view showing an operation of the dual-arm robot of FIG. 1.

FIG. 5E is a perspective view showing an operation of the dual-arm robot of FIG. 1.

FIG. 5F is a perspective view showing an operation of the dual-arm robot of FIG. 1.

FIG. 6 is a schematic diagram showing another configuration example of a container stack.

### DESCRIPTION OF EMBODIMENTS

Hereinafter, an embodiment of the present invention is described with reference to the drawings. In the drawings, the same or corresponding elements are denoted by the same reference signs, and repeating the same descriptions is avoided below. The drawings show each component schematically in order to facilitate the understanding thereof. Therefore, some elements that are irrelevant to the present invention may be omitted from the drawings, and there are cases where some of the drawings do not match each other. Also, the dimensions of the elements shown in the drawings are not necessarily precise.

### Embodiment

[Configuration]

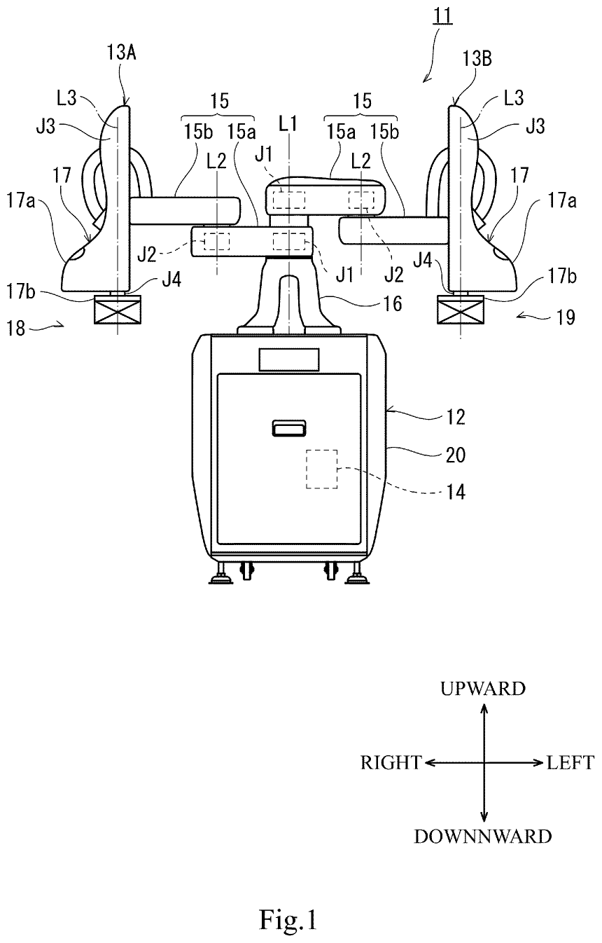

FIG. 1 is a front view showing the configuration of a robot according to the embodiment of the present invention. In the present embodiment, in FIG. 1, a direction in which a dual-arm robot 11 spreads a pair of arms thereof is referred to as a right-left direction; a direction parallel to the shaft center of a base shaft is referred to as an upward-downward direction; and a direction orthogonal to the right-left direction and the upward-downward direction is referred to as a front-rear direction.

With reference to FIG. 1, the dual-arm robot 11 includes: a base 12 fixed to a hand truck; a pair of arms (which may hereinafter be simply referred to as “arms”) 13A and 13B supported by the base 12; and a controller 14 accommodated in the base 12. The base 12 and the pair of arms 13A and 13B constitute the body of the dual-arm robot 11. Each of the arms 13A and 13B is a horizontal articulated arm configured to be movable relative to the base 12, and includes an arm part 15, a wrist part 17, and an end effector (18 or 19). It should be noted that the structure of the first arm (right arm) 13A and the structure of the second arm (left arm) 13B may be substantially the same as each other. The right arm 13A and the left arm 13B can be operated independently of each other, and also, can be operated in conjunction with each other. It should be noted that each of the arms 13A and 13B is only required to be a robotic arm, and is not limited to a horizontal articulated arm. For example, each of the arms 13A and 13B may be a general articulated arm. Also, the left arm may be the first arm, and the right arm may be the second arm.

In this example, the arm part 15 is constituted by a first link 15a and a second link 15b. The first link 15a is coupled by a rotary joint J1 to a base shaft 16, which is fixed to the upper surface of the base 12. The first link 15a is rotatable about a rotational axis L1, which extends through the shaft center of the base shaft 16. The second link 15b is coupled to the distal end portion of the first link 15a by a rotary joint J2. The second link 15b is rotatable about a rotational axis L2, which is defined at the distal end portion of the first link 15a.

The wrist part 17 is constituted by a lifting/lowering portion 17a and a rotating portion 17b. The lifting/lowering portion 17a is coupled to the distal end portion of the second link 15b by a prismatic joint J3. The lifting/lowering portion 17a is movable by being lifted/lowered relative to the second link 15b. The rotating portion 17b is coupled to the lower end of the lifting/lowering portion 17a by a rotary joint J4. The rotating portion 17b is rotatable about a rotational axis L3, which is defined at the lower end of the lifting/lowering portion 17a.

The end effectors (18 and 19) are coupled to the rotating portions 17b of the respective right and left wrist parts 17. The end effectors (18 and 19) are provided at the distal ends of the respective right and left arms 13. In this example, each of the end effectors (18 and 19) is configured as a hand. The configurations of the hands will be described below.

Each of the arms 13A and 13B configured as above includes the joints J1 to J4. Each of the arms 13 is provided with, for example: driving servomotors (not shown) corresponding to the respective joints J1 to J4; and encoders (not shown) configured to detect rotation angles of the respective servomotors. The rotational axes L1 of the respective first links 15a of the two arms 13A and 13B are positioned on the same straight line. The first link 15a of one arm 13 and the first link 15a of the other arm 13 are positioned at different heights such that they are displaced from each other in the upward-downward direction.

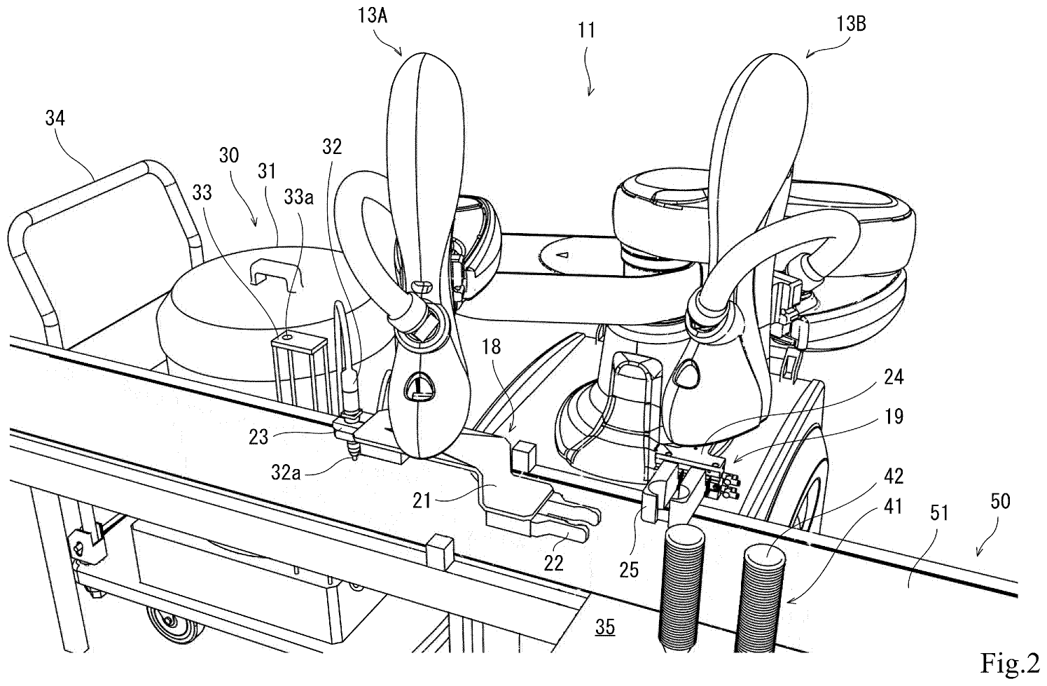

FIG. 2 is a perspective view showing the configurations of the hands of the dual-arm robot of FIG. 1, the perspective view illustrating an application example (usage example) of the dual-arm robot.

With reference to FIG. 1 and FIG. 2, the first arm 13A includes a first hand 18 as an end effector. The first hand 18 includes a base portion 21, a first gripper 22, and a second gripper 23. The base portion 21 is a bent plate-shaped portion, and includes a first portion and a second portion. The first portion extends horizontally (perpendicularly to the rotational axis L3). The second portion extends downward from one end of the first portion, and then extends horizontally. The center of the first portion is fixed to the rotating portion 17b. The first gripper 22, which includes a pair of claws, is provided on the distal end of the second portion. The pair of claws is provided such that the claws are able to open and close in the horizontal direction (perpendicular to the rotational axis L3). Groove-shaped recesses that correspond to the shape of a container are formed in the inner surfaces the pair of claws. In this example, each of the groove-shaped recesses has an arc-shaped cross section, such that the groove-shaped recesses form a pillar-like shape extending in the upward-downward direction (parallel to the rotational axis L3). Each of the pair of claws is constituted by a stiff body portion and an elastic layer covering the inner surface of the body portion. The stiff body portion is made of metal or resin, for example. The elastic layer is made of rubber or hard sponge, for example. Accordingly, when the pair of claws grips a container 42 in a sandwiching manner, the sandwiching force is applied to the container 42 in the horizontal direction, and in this manner, each of containers 42 of a container stack 41, in which the containers 42 are sequentially stacked upward, can be properly gripped. In addition, when the pair of claws grips the container 42 in the sandwiching manner, the elastic layers of the respective inner surfaces of the pair of claws are depressed, and friction force occurs between the container and the claws due to the elastic force of the elastic layers. As a result, the pair of claws can grip the container 42 without causing the container 42 to slip off the claws.

The second gripper 23, which includes a pair of claws, is formed on the other end of the first portion. The pair of claws is provided such that the claws are able to open and close in the horizontal direction (perpendicular to the rotational axis L3). Groove-shaped recesses that correspond to the shape of a container are formed in the inner surfaces the pair of claws. In this example, each of the groove-shaped recesses has an arc-shaped cross section, such that the groove-shaped recesses form a pillar-like shape extending in the upward-downward direction (parallel to the rotational axis L3). Each of the pair of claws is made of a material such as metal or resin, for example.

Each of the first gripper 22 and the second gripper 23 is configured as, for example, a chuck that is driven to open and close by air or a motor (in this example, air).

In the above configuration, the discharge direction of a discharger 32 gripped by the second gripper 23 of the first hand 18 of the first arm 13A coincides with the direction of the rotational axis L3, and the direction from the bottom portion to the top portion of the container 42 gripped by the first gripper 22 coincides with the direction of the rotational axis L3 (see FIG. 7E). According to this configuration, since the rotational axis L3 coincides with the vertical direction, even when the first arm is not controlled, the container 42 gripped by the first gripper 22 faces in the upward direction, and the discharge direction of the discharger 32 gripped by the second gripper 23 is the downward direction. This makes it possible to readily perform a container placing and food/drink material filling operation.

The second arm 13B includes a second hand 19 as an end effector. The second hand 19 includes a base portion 24 and a gripper 25. The base portion 24 is a flat plate-shaped portion, and one end thereof is fixed to the rotating portion 17b. The gripper 25, which includes a pair of claws, is provided on the other end of the base portion 24. The pair of claws is provided such that the claws are able to open and close in the horizontal direction (perpendicular to the rotational axis L3). Groove-shaped recesses that correspond to the shape of a container are formed in the inner surfaces the pair of claws. In this example, each of the groove-shaped recesses has an arc-shaped cross section, such that the groove-shaped recesses form a pillar-like shape extending in the upward-downward direction (parallel to the rotational axis L3). Each of the pair of claws is constituted by a stiff body portion and an elastic layer covering the inner surface of the body portion. The stiff body portion is made of metal or resin, for example. The elastic layer is made of rubber or hard sponge, for example. Accordingly, when the pair of claws grips a container 42 in a sandwiching manner, the sandwiching force is applied to the container 42 in the horizontal direction, and in this manner, each of the containers 42 of the container stack 41, in which the containers 42 are sequentially stacked upward, can be properly gripped. In addition, when the pair of claws grips the container 42 in the sandwiching manner, the elastic layers of the respective inner surfaces of the pair of claws are depressed, and friction force occurs between the container and the claws due to the elastic force of the elastic layers. As a result, the pair of claws can grip the container 42 without causing the container 42 to slip off the claws.

In the above configuration, the direction from the bottom portion to the top portion of the container 42 of the container stack 41 gripped by the gripper 25 of the second hand 19 of the second arm 13B coincides with the direction of the rotational axis L3 (i.e., the vertical direction) (see FIG. 7E).

The width (i.e., the dimension in the upward-downward direction) of the gripper 25 of the second arm 13B is greater than the width of the first gripper 22 of the first arm 13A. The reason for this is to allow the gripper 25 of the second arm 13B to stably hold the container stack 41 since the container stack 41 is held mainly by the gripper 25. The gripper 25 of the second arm 13B is configured as, for example, a chuck that is driven to open and close by air or a motor (in this example, air).

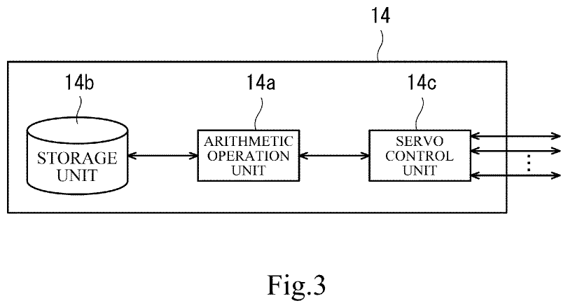

FIG. 3 is a functional block diagram schematically showing the configuration of a control system of the dual-arm robot 11. As shown in FIG. 3, the controller 14 includes an arithmetic operation unit (processor) 14a, a storage unit 14b, and a servo control unit 14c. The controller 14 is configured as, for example, a microcontroller, an MPU, an FPGA (Field Programmable Gate Array), or a PLC (Programmable Logic Controller). The arithmetic operation unit 14a is configured as, for example, a processor of a microcontroller or the like. The storage unit 14b is configured as a memory of, for example, the microcontroller. The controller 14 may be configured as a single controller performing centralized control, or may be configured as a plurality of controllers performing distributed control in cooperation with each other.

The storage unit 14b stores a basic program as a robot controller program and information such as various fixed data. The arithmetic operation unit 14a controls various operations of the dual-arm robot 11 by loading and executing, for example, the basic program stored in the storage unit 14b. Specifically, the arithmetic operation unit 14a generates a control command for the dual-arm robot 11, and outputs the generated control command to the servo control unit 14c. The servo control unit 14c is configured to control the driving of the servomotors corresponding to the joints J1 to J4 of each of the arms 13 of the dual-arm robot 11 based on the control command generated by the arithmetic operation unit 14a. The controller 14 also controls the operations of the first gripper 22 and the second gripper 23 of the first hand 18 and the operations of the gripper 25 of the second hand. Thus, the controller 14 controls the operations of the overall dual-arm robot 1.

### Application Example

Next, an application example (usage example) of the dual-arm robot 11 configured as above is described with reference to FIG. 2.

<Working Site>

With reference to FIG. 2, the dual-arm robot 11 is applied to, for example, a working site where the work of filling containers 42 with a food/drink material having fluidity (a food, a drink, or ingredients thereof) is performed. At the working site, a conveying apparatus 50 is installed, which is configured to move a conveying body 51 to convey an object (in this example, a container 42) placed on the conveying body 51. In this example, the conveying body 51 is a belt, and the conveying apparatus 50 is a belt conveyor. Necessary equipment, tools, workers, etc., for performing the work are arranged on both sides of the conveying body 51. The dual-arm robot 11 is a machine for automatically placing the container 42 on the conveying body 51 and filling the container 42 placed on the conveying body 51 with the food/drink material. In this example, the food/drink material is a dressing. As shown in FIG. 2, the dual-arm robot 11 can be installed in a limited space that is in the size of one person (e.g., 610 mm×620 mm). A food/drink material feeder 30 is disposed on the right side of the dual-arm robot 11. The food/drink material feeder 30 is placed on a hand truck 34. Thus, the food/drink material feeder 30 for feeding the food/drink material, with which to fill the containers 42, is placed on the hand truck 34, and a worker carries the food/drink material feeder 30 with the hand truck 34 and positions the food/drink material feeder 30 at a predetermined position. The food/drink material feeder 30 includes a food/drink material tank 31, the discharger 32, and a discharger stand 33. The food/drink material tank 31 stores therein the food/drink material having fluidity. The discharger 32 includes an inlet provided at its proximal end portion, and the inlet is connected to the food/drink material tank 31 by a feed pipe. The discharger 32 also includes a discharge outlet 32a provided at its distal end portion. The discharger stand 33 is provided at a suitable position on the food/drink material feeder 30. A placing board is disposed on the top of the discharger stand 33, and a through-hole 33a is formed in the placing board. The discharger 32 is carried in the state of being inserted in the through-hole 33a, with the discharge outlet 32a facing downward. When the work of filling the containers 42 with the food/drink material is started, the discharger 32 is gripped by the second gripper 23 of the first hand 18 of the first arm 13A of the dual-arm robot 11. At the time, the second gripper 23 grips the center portion of the discharger 32.

Meanwhile, a container stand 35 is disposed in front of the conveying body 51 near the first arm of the dual-arm robot 11. A plurality of container stacks 41 are arranged on the container stand 35 at their predetermined positions.

<Container Stack>

Each of the containers 42 is required to have an open top portion, a closed bottom portion, and such a shape that each container 42 gets gradually thinner from the top portion to the bottom portion. In this example, each container 42 is a cup.

Each of the container stacks 41 is a stack of the containers that are sequentially stacked such that every two containers adjacent to each other in the upward-downward direction in the stack are arranged in such a manner that the upper one of the two containers is inserted from its bottom portion into the internal space of the lower one of the two containers, such that the top portion of the upper container is exposed. In other words, each container stack 41 is formed by stacking the containers 42 in a non-inverted manner. The “non-inverted” stacking herein is the opposite of “inverted” stacking, and the “non-inverted” stacking means that each container 42 in the stack is in such an orientation that the direction from the bottom portion to the top portion of the container 42 is the upward direction.

### Operation Examples

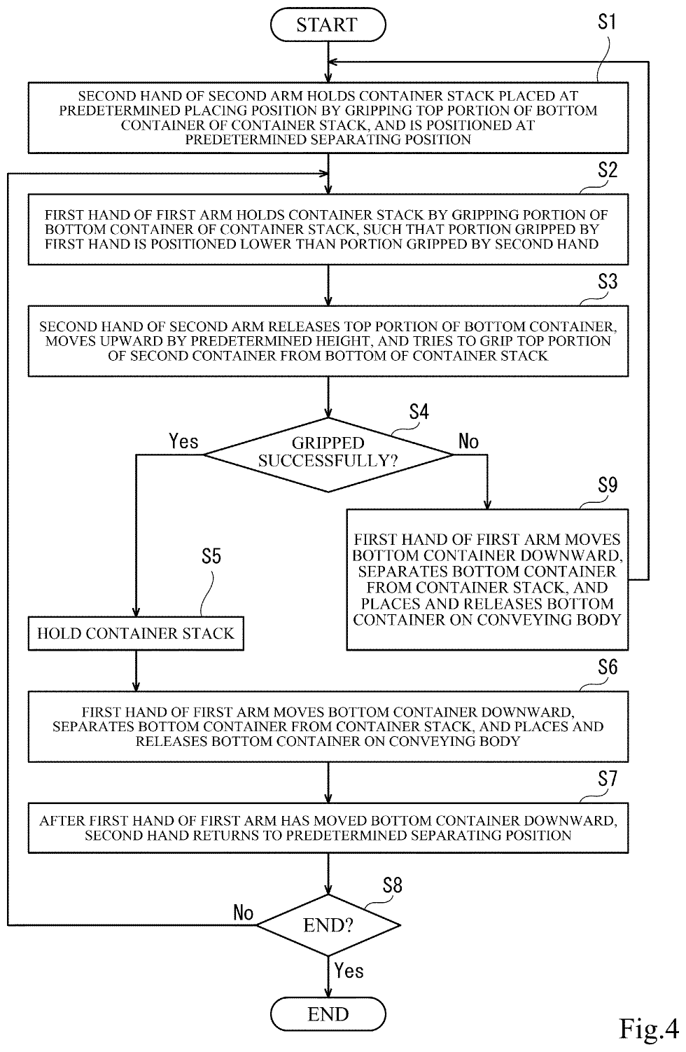

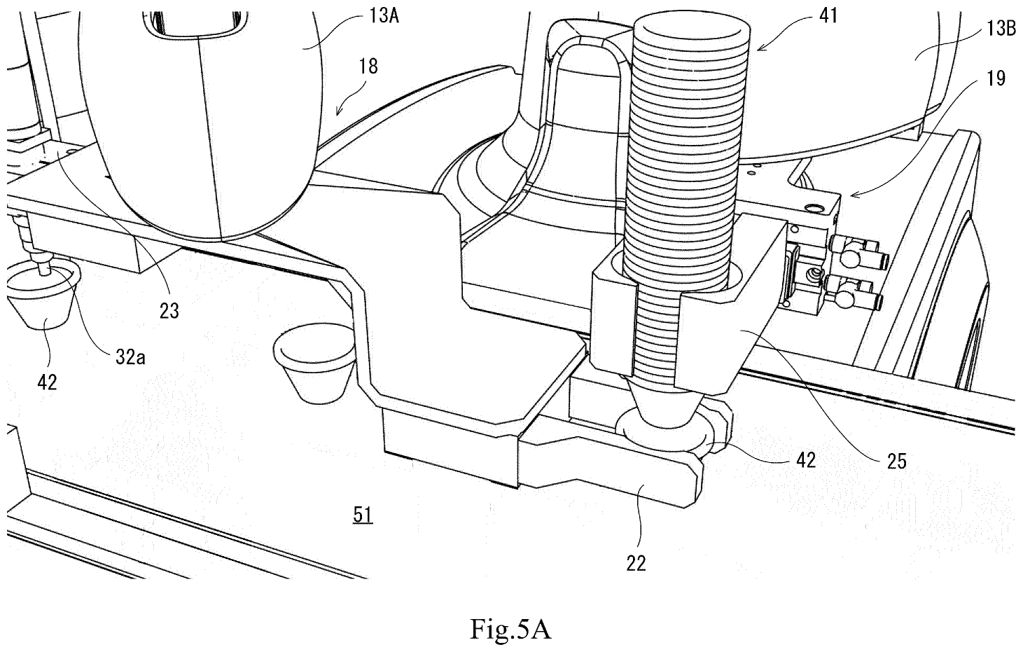

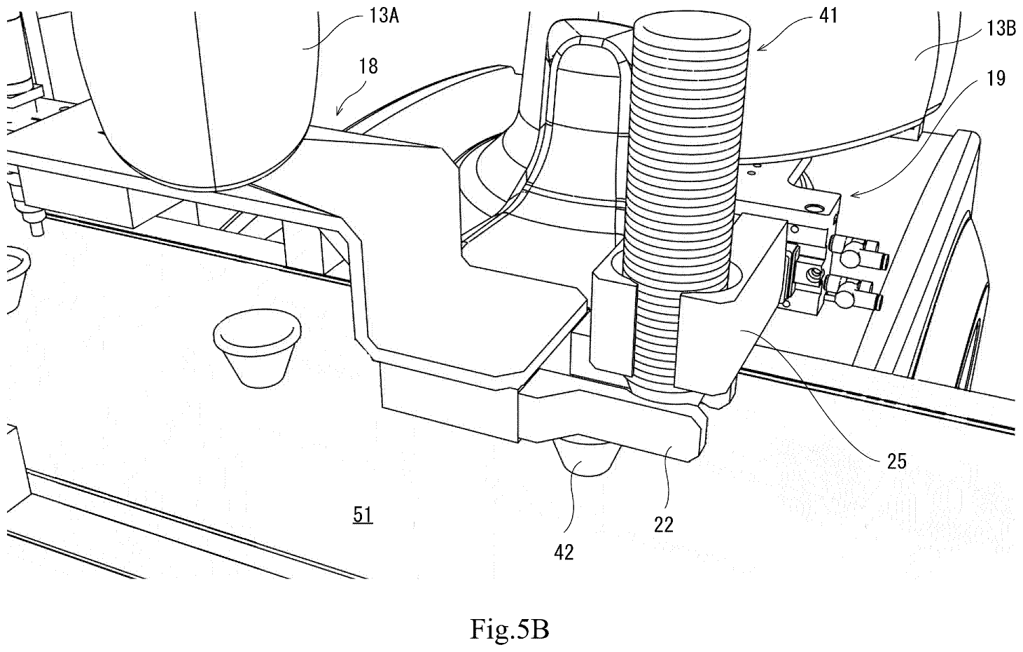

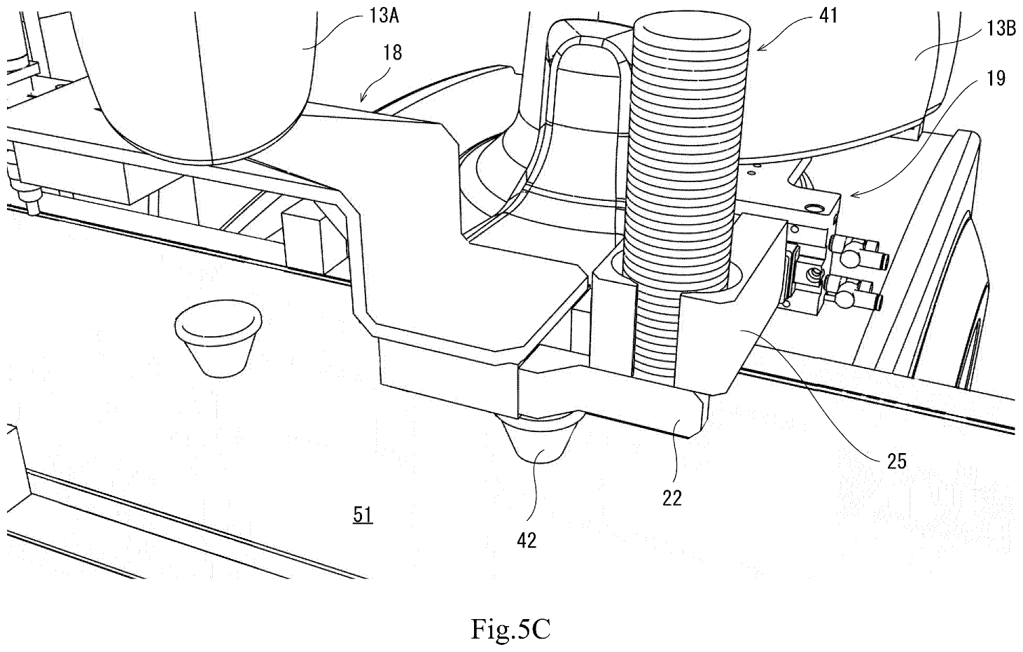

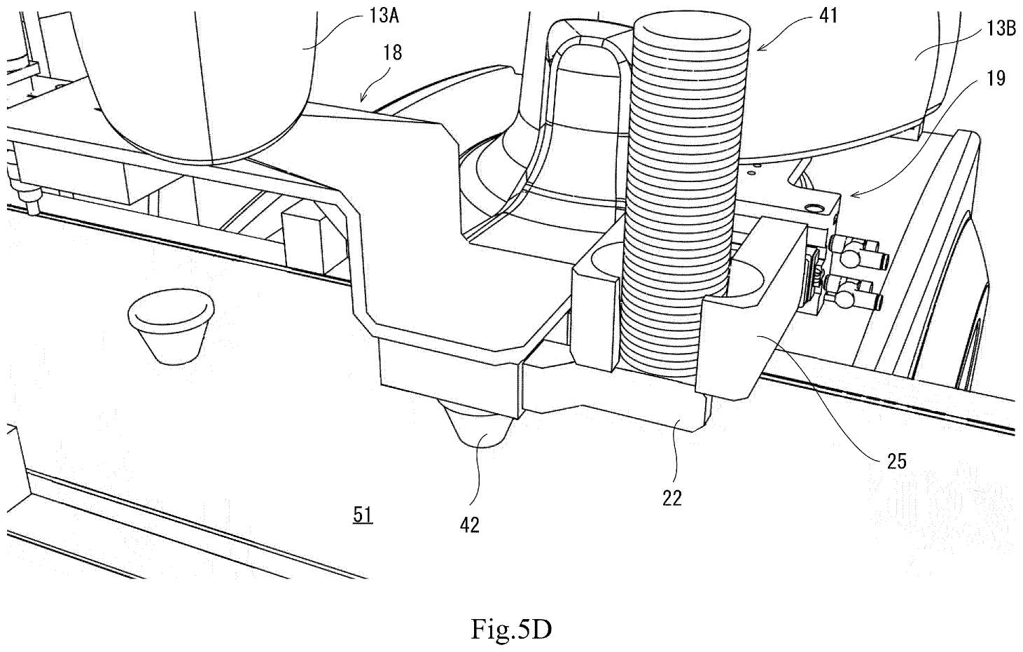

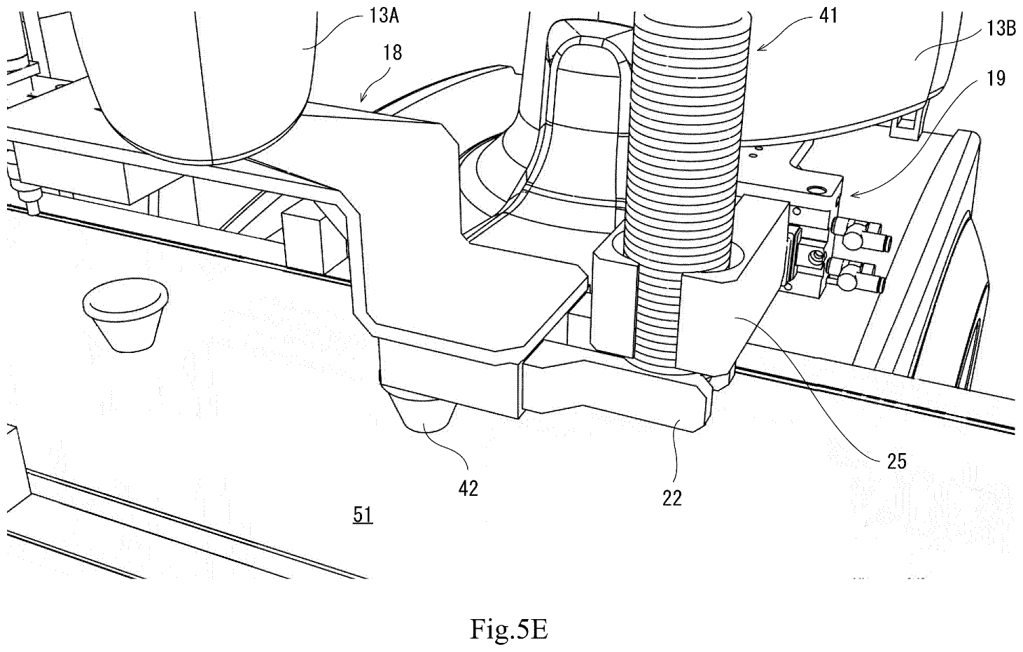

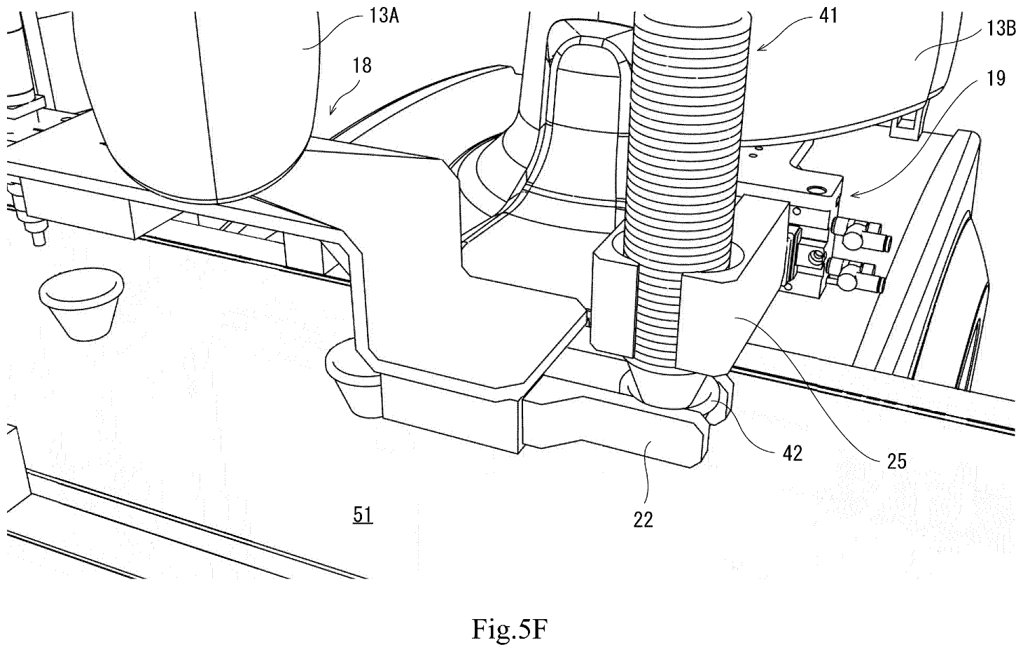

Next, operations of the dual-arm robot configured as above are described based on FIG. 2, FIG. 4, and FIGS. 5A to 5F. The operations are performed as a result of the controller 14 controlling the dual-arm robot 11. FIG. 4 is a flowchart showing the operations of the dual-arm robot of FIG. 1. FIGS. 5A to 5F are perspective views showing the operations of the dual-arm robot of FIG. 1. It should be noted that, hereinafter, for the purpose of simplifying the description, an operation of “a gripper of a hand” may be expressed as an operation of “a hand (gripper)”.

As shown in FIG. 2, when the work of filling the containers 42 with the food/drink material is started, the first arm 13A of the dual-arm robot 11 grips, by the second gripper 23, the center portion of the discharger 32 placed on the discharger stand 33. Thereafter, the first hand 18 of the first arm 13A takes, when seen in a plan view, such a posture that the first gripper 22 is positioned at a container placing position on the moving path of the conveying body 51, and that the discharge outlet 32a of the discharger 32 gripped by the second gripper 23 is positioned at a food/drink material filling position on the moving path of the conveying body 51. When seen in a plan view, the container placing position and the food/drink material filling position are positioned on a straight line that coincides with the moving direction of the conveying body 51, and the food/drink material filling position is positioned downstream of the container placing position. The moving speed of the conveying body 51 is set to a predetermined speed. In this state, the dual-arm robot 11 performs a container separating operation (container placing operation) as described below.

Next, as shown in FIG. 5A, the second hand 19 (gripper 25) of the second arm 13B holds a container stack 41 placed at its predetermined placing position on the container stand 35 by gripping the top portion of the bottom one of the containers 42 of the container stack 41, and is positioned at a predetermined separating position (step S1). The separating position is a position immediately above the container placing position. It should be noted that FIG. 5A shows a state in which the first hand 18 (first gripper 22) has released and placed, on the conveying body 51, a container 42 separated from the container stack 41 by a previously performed container separating operation.

Next, as shown in FIG. 5B, the first hand 18 (first gripper 22) of the first arm 13A starts moving upward.

Next, as shown in FIG. 5C, the first hand 18 (first gripper 22) of the first arm 13A holds the container stack 41 by gripping a portion of the bottom container 42 of the container stack 41, such that the portion gripped by the first hand 18 (first gripper 22) is positioned lower than the portion gripped by the second hand 19 (gripper 25) (step S2).

Next, as shown in FIG. 5D, the second hand 19 (gripper 25) of the second arm 13B releases the top portion of the bottom container 42 (step S3).

Next, as shown in FIG. 5E, the second hand 19 (gripper 25) of the second arm 13B moves upward by a predetermined height, and tries to grip the top portion of the second container 42 from the bottom of the container stack 41 (step S4). Here, since the second container 42 is present above the bottom container 42, the second hand 19 (gripper 25) of the second arm 13B grips the top portion of the second container 42 successfully (YES in step S4).

Then, the second hand 19 (gripper 25) of the second arm 13B holds the container stack 41 (step S5).

Next, as shown in FIG. 5F, the first hand 18 (first gripper 22) of the first arm 13A moves the bottom container 42 downward, separates the bottom container 42 from the container stack 41, and places and releases the bottom container 42 on the conveying body 51 (step S6).

Next, as shown in FIG. 5A, after the first hand 18 (first gripper 22) of the first arm 13A has moved the bottom container 42 downward, the second hand 19 (gripper 25) returns to the predetermined separating position (step S7).

In step S4, if no container 42 is present above the bottom container 42, i.e., if the container 42 currently gripped by the first hand 18 (first gripper 22) of the first arm is the top container (i.e., the last container) of the container stack 41, then the try to grip the second container from the bottom of the container stack 41 fails (NO in step S4). In this case, in the container separating operation, the first hand 18 (first gripper 22) of the first arm moves the bottom container 42 downward, separates the bottom container 42 from the container stack 41, and places and releases the bottom container 42 on the conveying body 51 (step S9). Thereafter, returning to step S1, the second hand (gripper 25) grips the next container stack 41, and is positioned at the separating position.

After step S7, the controller 14 determines whether or not to end the container separating operation (step S8). If the controller 14 determines not to end the container separating operation (NO in step S8), the controller 14 returns to step S2. If the controller 14 determines to end the container separating operation (YES in step S8), the controller 14 ends the container separating operation.

Concurrently with the container separating operation, the food/drink filling operation is performed in a manner described below.

With reference to FIG. 2 and FIG. 5A, when the container 42 placed at the container placing position on the conveying body 51 is positioned to the food/drink material filling position, the food/drink material is discharged into the container 42 from the discharge outlet 32a of the discharger 32 gripped by the second gripper 23 of the first hand 18 of the first arm 13A, thereby filling the container 42 with the food/drink material. In this example, a duration of time (a cycle time) over which the container 42 is placed at the container placing position on the conveying body 51 is set to 1/(integer) of a time over which the container 42 is moved between the container placing position and the food/drink material filling position (in this example, 1/2). Therefore, a sensor for detecting whether or not the container 42 has been positioned to the food/drink material filling position is unnecessary. Moreover, the discharging of the food/drink material is properly performed by the food/drink material feeder 30 and the dual-arm robot 11 in cooperation with each other. Since this discharging operation is not directly relevant to the present invention, a further description thereof is omitted herein.

As described above, according to the present embodiment, the first and second arms 13A and 13B hold the container stack 41 by the second arm 13B, then re-hold it by the first arm 13A, and thereafter re-hold it by the second arm 13B, sequentially. In a state where the second arm 13B holds the container stack 41 by gripping the top portion of the second container from the bottom of the container stack 41, the first arm 13A moves the bottom container downward, thereby separating the bottom container 42 from the container stack 41. In this manner, automatic feeding of each container 42 can be performed by using the arms 13A and 13B. In addition, since the feed speed of the containers 42 depends on the operating speed of the arms 13A and 13B, by increasing the operating speed of the arms 13A and 13B, the feed speed of the containers 42 (i.e., work efficiency) can be improved.

[Variations]

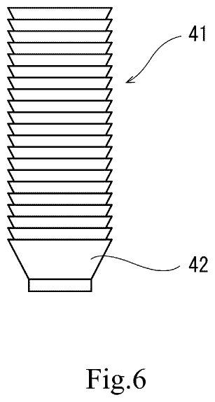

FIG. 6 is a schematic diagram showing another configuration example of the container stack 41. With reference to FIG. 6, in this variation, each of the containers 42 is a tea bowl. A plurality of the tea bowls 42 are sequentially stacked such that every two tea bowls 42 adjacent to each other in the upward-downward direction in the tea bowl stack are stacked in such a manner that the upper one of the two tea bowls 42 is inserted from its bottom portion into the internal space of the lower one of the two tea bowls 42, such that the top portion of the upper tea bowl 42 is exposed.

According to the dual-arm robot 11 of the present embodiment, also when the container stack is the above-described tea bowl stack 41, the container separating operation can be properly performed, and thereby automatic feeding of the tea bowls 42 can be performed.

### Other Embodiments

The containers are not limited to the above-described examples, but may be trays, bowls, dishes, etc.

The working site is not limited to a working site relating to food products, but may be a different kind of working site, so long as the working site is a site where a robot and a worker work together in the same working space in cooperation with each other.

From the foregoing description, numerous modifications and other embodiments of the present invention are obvious to a person skilled in the art. Therefore, the foregoing description should be interpreted only as an example and is provided for the purpose of teaching the best mode for carrying out the present invention to a person skilled in the art. The structural and/or functional details may be substantially altered without departing from the spirit of the present invention.

### INDUSTRIAL APPLICABILITY

The robot and the method of operating the same according to the present invention are useful as a robot capable of automatically feeding containers by using arms and a method of operating the robot.

### REFERENCE SIGNS LIST

11 dual-arm robot
12 base
13A first arm
13B second arm
14 controller
14a arithmetic operation unit (processor)
14b storage unit
14c servo control unit
15 arm part
15a first link
15b second link
16 base shaft
17 wrist part
17a lifting/lowering portion
17b rotating portion
18 first hand (end effector)
19 second hand (end effector)
21 base portion
22 first gripper
23 second gripper
24 base portion
25 gripper
30 food/drink material feeder
31 food/drink material tank
32 discharger
32a discharge outlet
33 discharger stand
33a through-hole
34 hand truck
35 container stand
41 container
42 container stack
50 conveying apparatus
51 conveying body

1. A robot for sequentially separating containers from a container stack,
each of the containers having an open top portion, a closed bottom portion, and such a shape that each container gets gradually thinner from the top portion to the bottom portion,
the container stack being a stack of the containers that are sequentially stacked such that every two containers adjacent to each other in an upward-downward direction in the stack are arranged in such a manner that an upper one of the two containers is inserted from its bottom portion into an internal space of a lower one of the two containers, such that the top portion of the upper container is exposed,
the robot comprising:
a first arm including a first hand at a distal end thereof, the first hand being operable to grip each of the containers;
a second arm including a second hand at a distal end thereof, the second hand being operable to grip each of the containers; and
a controller configured to control operations of the first and second arms, wherein
the controller is configured to control the first and second arms such that:
the second hand of the second arm holds the container stack by gripping the top portion of a bottom one of the containers of the container stack;
then, the first hand of the first arm holds the container stack by gripping a portion of the bottom container of the container stack, such that the portion gripped by the first hand is positioned lower than the portion gripped by the second hand;
thereafter, the second hand of the second arm releases the top portion of the bottom container, and then holds the container stack by gripping the top portion of a second container from a bottom of the container stack; and
subsequently, the first hand of the first arm moves the bottom container downward, and separates the bottom container from the container stack.

2. The robot according to claim 1, wherein
the controller is configured to control the first and second arms such that:
when the second hand of the second arm holds the container stack by gripping the top portion of the bottom container of the container stack, the second hand is positioned at a predetermined height position, and
then, the second hand moves upward by a predetermined height before the second hand grips the top portion of the second container from the bottom of the container stack, and the second hand returns to the predetermined height position after the first hand of the first arm has moved the bottom container downward.

3. The robot according to claim 1, wherein
each of the first hand and the second hand is configured to grip each of the containers by applying sandwiching force to the gripped container in a horizontal direction.

4. The robot according to claim 1, wherein
each of the containers is a cup.

5. A method of operating a robot for sequentially separating containers from a container stack,
each of the containers having an open top portion, a closed bottom portion, and such a shape that each container gets gradually thinner from the top portion to the bottom portion,
the container stack being a stack of the containers that are sequentially stacked such that every two containers adjacent to each other in an upward-downward direction in the stack are arranged in such a manner that an upper one of the two containers is inserted from its bottom portion into an internal space of a lower one of the two containers, such that the top portion of the upper container is exposed,
the robot including:
a second arm including a second hand at a distal end thereof, the second hand being operable to grip each of the containers; and
a first arm including a first hand at a distal end thereof, the first hand being operable to grip each of the containers,
the method comprising:
holding the container stack by gripping the top portion of a bottom one of the containers of the container stack by the second hand of the second arm;
then, holding the container stack by gripping a portion of the bottom container of the container stack by the first hand of the first arm, such that the portion gripped by the first hand is positioned lower than the portion gripped by the second hand;
thereafter, releasing the top portion of the bottom container by the second hand of the second arm;
then, holding the container stack by gripping the top portion of a second container from a bottom of the container stack by the second hand of the second arm; and
subsequently, moving the bottom container downward and separating the bottom container from the container stack by the first hand of the first arm.

6. The method of operating a robot according to claim 5, comprising:
positioning the second hand of the second arm at a predetermined height position when holding the container stack by gripping the top portion of the bottom container of the container stack by the second hand; and
then, moving the second hand upward by a predetermined height before the second hand grips the top portion of the second container from the bottom of the container stack, and returning the second hand to the predetermined height position after the first hand of the first arm has started moving the bottom container downward.

7. The method of operating a robot according to claim 5, wherein
each of the first hand and the second hand is configured to grip each of the containers by applying sandwiching force to the gripped container in a horizontal direction.

8. The method of operating a robot according to claim 5, wherein
each of the containers is a cup.
